(19) United States
(12) Patent Application Publication
(10) Pub. No.: US 2012/0128907 A1
(43) Pub. Date: May 24, 2012

(54) RADIO FREQUENCY SEALABLE FILM, SEALED FILM STRUCTURE AND METHOD OF MAKING THE SAME

(76) Inventors: Michael Mounts, Midland, MI (US); Jeffrey Bonekamp, Midland, MI (US)

(21) Appl. No.: 13/387,840

(22) PCT Filed: Aug. 5, 2010
(86) PCT No.: PCT/US2010/044480

§ 371 Date: Jan. 30, 2012

Related U.S. Application Data
(60) Provisional application No. 61/231,871, filed on Aug. 6, 2009.

(51) Int. Cl. B32B 7/10; B32B 27/32; B32B 37/06; B32B 27/08

(52) U.S. Cl. 428/35.2; 428/355 EN; 428/354; 428/521; 428/519; 156/273.3

(57) ABSTRACT

Radio frequency sealable films and sealed film structures are disclosed where the film comprises an outer seal layer and a substantially adjacent radio frequency receptive layer, wherein the outer seal layer consists essentially of a substantially isotactic polypropylene composition and the radio frequency receptive layer comprises a radio frequency receptive material.

### CROSS REFERENCE STATEMENT

This application claims the benefit of U.S. Provisional Application No. 61/231,871, filed Aug. 6, 2009, the entire content of which is incorporated herein by reference.

### BACKGROUND OF THE INVENTION

1. Field of the Invention

The present invention relates to radio frequency (RF) sealable films and improved, sealed film structures.

2. Discussion of the Related Art

Films and film structures are used in various and numerous applications. For example, film structures can be beneficial in packaging applications. Examples of packaging applications include food and medical packaging applications.

Film structures may be monolayer structures or may have multiple layers. Furthermore, each layer may be comprised of multiple materials or compositions. In addition, each layer may provide different functionality to the film structure. Functionalities that are desirable may include, for example, abuse resistance, barrier to oxygen, moisture and/or odor, and adhesion to adhere, i.e., tie, the various layers together. Properties of the film structure provided at least in part by the outside, or seal, layer can include but are not limited to chemical resistance, gloss, clarity, sealability and stiffness of the structure.

Specifically, the outer or outside layer of the film often needs to be sealable in order for the film to be converted into a film structure for a packaging application. Radio frequency (RF) sealing is often a preferred option for sealing thicker films to form film structures or for imparting specific seal designs. Radio frequency (RF) electromagnetic energy may be used to heat and seal polymeric materials. RF range is typically from 1 to 300 MHz. Some polymers do not respond to RF energy and do not produce an effective seal. Some polymers eventually seal after an inefficiently long sealing time yielding long cycle times and/or require very high power which can result in reduced equipment lifetime or possible dielectric breakdown of the film structure. Thus, these polymers are not as commercially viable as RF sealable layers.

Moreover, common packaging applications often require chemical resistance to substances such as but not limited to oils such as vegetable oil, alcohols such as ethyl alcohol, acids such as acetic acid, and/or bases such as sodium hydroxide. For example, even though commonly used in some food packaging, copolymers of ethylene and vinyl acetate can show poor resistance to vegetable oils especially when the vinyl acetate content is above about 18 weight percent, which limits their usefulness in some food packaging applications. Similarly, polyamide polymers show poor resistance to acids and therefore, have limited application. Polypropylene polymers and copolymers are often selected for the outside sealable layer in heat sealable multilayer film structures because of their chemical resistance to such substances above as well as their relatively low cost. Also, such desired chemical resistance of the subsequent package can only be realized if the seal in the propylene based layer is contiguous in the same chemical resistant material. However, polypropylene polymers are not known or considered to be RF sealable.

U.S. Pat. No. 6,488,972B1 discusses RF sealable film structures containing polypropylene, however, polypropylene is not in the seal, i.e. sealable, layer. U.S. Pat. No. 5,565,250A discloses RF sealable multilayer films where polypropylene is used in a barrier layer but not in the seal layer.

Moreover, U.S. Pat. No. 5,693,387A teaches that polypropylene is not RF sealable without blending it with an RF active material. U.S. Pat. No. 5,656,374A discloses that it is essential to blend 3 to 15 percent of at least one polymer having a dielectric heat loss factor greater than or equal to 0.01 with polyolefin compositions comprising propylenes to establish RF seals. U.S. Publication 20050255328A1 discloses blends of ethylene-propylene copolymers with organic acid salt-modified potassium ionomeric copolymers to obtain RF seals. U.S. Pat. No. 5,272,210A teaches RF sealable polymer blends containing propylene-ethylene copolymer and ethylene-alkyl acrylate copolymer, but does not disclose seals with propylene-ethylene copolymers alone. Not only are such blends in seal layers susceptible to reduction of their chemical resistance by addition of polar RF active material (typically less chemical resistant), but the seal layers can also contribute to poor clarity or high haze in the article or structure where blending together immiscible materials with different indices of refraction.

U.S. Pat. No. 5,577,369A teaches a peelable seal between non-RF active layers adjacent to RF responsive layers where the seal layer is comprised of a blend of ethylene propylene copolymers and SEBS. However, the seal is established only between the SEBS surface layer giving only peelable seal strength and a true high strength seal is not established in the ethylene propylene copolymer phase. Here the seal of a subsequent package would be between the non-propylene polymer such that the good chemical resistance of propylene may not be obtained and the seal could be attacked by chemical contents of the package.

German Patent DE 4228115A teaches a two layer structure where an RF receptive polymer layer having a melting point above that of a second seal layer of polyolefin is used to prevent film from sticking to an RF sealer. However, it is often preferable to use RF receptive materials having lower melting points than materials in the seal layer in multilayer structures and especially advantageous to have the same or very similar melt temperatures for making both fin seals (inside of film structure to inside of film structure) and lap seals (inside of film structure to outside of film structure) as in, for example, vertical form fill sealing operations.

Accordingly, these materials and articles made from these materials are disadvantageous for use in various applications where RF sealing is required to obtain either peelable or non-peelable seals, including fin and/or lap seals, as well as desired or required properties, including but not limited to, chemical resistance, low cost, stiffness, machinability, and/or high clarity. It would be advantageous for multilayer film structures to have some or all of these desired properties. Therefore, there exists a need for sealable films and sealed multilayer film structures having improvements in one or more of these desired properties.

### SUMMARY OF THE INVENTION

Accordingly, the present invention is directed to radio frequency sealable films, sealed film structures and methods of making the same that substantially obviate one or more problems due to limitations and disadvantages of the related art. In one embodiment the present invention is a radio frequency sealable film, comprising an outer seal layer and a substantially adjacent radio frequency receptive layer, wherein the outer seal layer consists essentially of a substantially isotactic polypropylene composition and the radio frequency receptive layer comprises a radio frequency receptive material. In alternative embodiments such films comprise at least three layers including another outer layer or at least five layers, including an inner barrier layer, which barrier composition may comprise at least one polymer selected from the group of polyvinylidene chloride copolymers, polyamides, polyesters, copolymers of ethylene and vinyl alcohol, high density polyethylene and polyacrylonitrile. In some of the possible film embodiments of the invention, there are two outer seal layers which independently consist essentially of substantially isotactic polypropylene composition(s) on opposing sides, each substantially adjacent to radio frequency receptive layers.

Other embodiments include such films where the substantially isotactic polypropylene in the outer seal layer composition comprises at least about 87 weight percent propylene units and between about 1 and about 13 weight percent ethylene units or comprises at least 91 weight percent propylene units and up to about 9 weight percent ethylene units. In other embodiments the substantially isotactic polypropylene composition has a melt flow rate of about 0.5 to about 12.0 g/10 minutes at 230 deg4rees Celsius/2.16 kilograms and/or may comprise a blend of two or more substantially isotactic polypropylene compositions wherein each composition has a different ethylene unit content.

In further alternative film embodiments of the present invention, the radio frequency receptive material composition may have a dielectric loss factor of at least about 0.5 and/or may be selected from the group consisting of: copolymers of ethylene and vinyl acetate; copolymers of ethylene and methyl acrylate; copolymers of ethylene and ethyl acrylate; copolymers of ethylene and carbon monoxide; copolymers of ethylene and n-butyl acrylate; terpolymers of ethylene, acrylic acid and carbon monoxide; terpolymers of ethylene, n-butyl acrylate and carbon monoxide; terpolymers of ethylene, methacrylic acid and carbon monoxide; terpolymers of ethylene, vinyl acetate and carbon monoxide; anhydride modified terpolymers of ethylene, vinyl acetate and carbon monoxide; polyamides; polyesters; and thermoplastic urethanes. A possible radio frequency receptive material composition comprises: (a) from about 40 to 80 weight percent ethylene/vinyl acetate copolymer which comprises from about 15 to about 35 weight percent vinyl acetate and (b) from about 20 to about 60 weight percent ethylene/vinyl acetate/carbon monoxide terpolymer which comprises from about 2 to about 12 weight percent carbon monoxide and from about 13 to about 30 weight percent vinyl acetate.

In other possible film embodiments, the thickness of the radio frequency receptive layer is in the range of from about 12 volume percent to about 40 volume percent of the total thickness of the film and/or the outer seal layer and the radio frequency receptive layer are directly adjacent and in contact. A further embodiment of the present invention is a method of making a seal between film surfaces, comprising: applying radio frequency energy to a sealing area of a multilayer film embodiment of the present invention, which applied energy is sufficient to heat the sealing area to a sealing temperature; and contacting and sealing the sealing area to another sealing area on a surface of the same film or a different film to provide a seal between the contacted sealing areas of the film surfaces. In a further alternative method embodiment of the present invention, the radio frequency energy is applied for less than seven seconds.

Further embodiments include a sealed film structure made by a method embodiment, a sealed film structure wherein the seal has a seal strength of greater than about 0.5 Newtons per millimeter (N/mm) (2.9 pounds per in (lb/in)) or has a peelable seal strength greater than about 0.08 N/mm (0.46 lb/in) but less than about 0.8 N/mm (4.6 lb/in). The present invention is also such a fin- or lap-sealed film structure, wherein the seal layers that are sealed together consist essentially of substantially isotactic polypropylene composition, which can be the same or different substantially isotactic polypropylene compositions.

Advantages that may be obtainable according to one or more embodiments of the present invention include providing: an RF sealable film, such as a multilayer film; either a peelable or a non-peelable seal in an RF-sealed film structure; an RF sealable film, such as a multilayer film, in which preferred high clarity or low haze may be exhibited in the film; an RF sealable film, such as a multilayer film, with preferred and/or required levels of film and film seal chemical resistance provided by polypropylene resins; an RF sealable film, such as a multilayer film, in which optional or required barrier properties may be exhibited; and/or an RF sealable film which may be RF-sealed in a relatively short or reduced seal time yielding a reduced sealing cycle time.

Additional features and advantages of the invention will be set forth in the description which follows, and in part will be apparent from the description, or may be learned by practice of the invention. The advantages of the invention may be realized and attained by the structure and method particularly pointed out in the written description and claims hereof as well as the appended figures. It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 illustrates a fin seal having a seal area 6 using a multilayer film according to an embodiment of the present invention;

FIG. 2 illustrates a lap seal having a seal area 6 using a multilayer film according to an embodiment of the present invention; and

FIG. 3 illustrates a cross sectional view generally showing one possible layer structure for a multilayer film according to an embodiment of the present invention.

### DETAILED DESCRIPTION OF THE INVENTION

Reference will now be made in detail to embodiments of the present invention, examples of which are disclosed in the specification. It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

Numerical ranges include all values from and including the lower and upper values, in increments of one unit, provided that there is a separation of at least two units between any lower value and any higher value. As an example, if a compositional, physical or other property, such as, for example, thickness, density, molecular weight, monomer content, melt flow rate, etc. is greater than 10, it is intended that all individual values, such as 10, 11, 12, etc. and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.01, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered expressly stated in this disclosure.

The term “or,” unless stated otherwise, refers to the listed members individually as well as in any combination of two or more of the members.

As used with respect to a chemical compound, unless specifically indicated otherwise, the singular includes all isomeric forms and vice versa (for example, “hexane” includes all isomers of hexane individually or collectively).

“Blend,” “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

The term “polymer” refers to a macromolecular compound prepared by polymerizing one or more monomers, whether of the same or a different type. The generic term polymer thus embraces the term “homopolymer,” usually employed to refer to polymers prepared from only one type of monomer, as well as “copolymer” and “interpolymer,” usually employed to refer to polymers prepared from two or more different monomers. “Composition” as used herein refers to when a material, such as a polymer or a RF receptive material, optionally contains additional or multiple components, and typically refers to a “polymer” with optional additives or other polymers blended in.

The term “crystallinity” refers to the regularity of the arrangement of atoms or molecules forming a crystal structure. Polymer crystallinity can be examined using known techniques, such as differential scanning calorimetry (DSC).

“Mer unit” means that portion of a polymer derived from a single reactant molecule. For example, a mer unit from ethylene has the general formula —CH₂CH₂—. As used herein, when the “polymers” are said to incorporate, contain or comprise one or more “monomer”, this refers to the fact that the monomer is polymerized therein and present structurally as a remnant “mer unit”, not as the starting monomer molecule.

“Polypropylene,” “propylene polymer” or “polypropylene polymer” means a polymer having at least half of its mer units derived from propylene. These include homopolymers of propylene as well as copolymers or interpolymers of propylene with one or more monomers with which it (i.e., propylene) is copolymerizable such as ethylene, 1-butene, 1-pentene, 1-hexene, 1-octene, one or more conjugated or non-conjugated dienes, and combinations of two or more of these comonomers.

“Radio frequency (RF) receptive,” “RF receptivity,” “RF activity” and like terms refer to a material susceptible to dielectric activation via application of electromagnetic energy in the RF range, the application of which induces rapid heating of the material. “RF sealing,” “RF bonding” and “RF welding” refers to bonding of a sealable article to a portion of itself or to another article using electromagnetic energy over an RF frequency range, generally ranging from about 1 Megahertz (MHz) to about 300 MHz. Preferably, the RF frequency employed is greater than 5 MHz, preferably greater than about 10 MHz, and more preferably greater than about 12 MHz. Further, depending on the specific applications and conditions, such as manufacturing and processing conditions, cost limitations and other optimizations, the RF frequency used may be less than about 200 MHz, preferably less than about 100 MHz and more preferably less than about 45 MHz.

RF receptivity, RF activity, etc. is reflected by the dielectric loss factor of a particular material composition, such as a polymer composition. “Dielectric loss factor” is a calculated value determined by multiplying a material's dielectric constant (DC) by its dielectric dissipation factor (DDF) (or loss tangent). The DC and DDF are readily determined by instrumented dielectric testing methods. A preferred test method utilizes a Hewlett-Packard Impedance/Material Analyzer, model 4291B coupled with a Hewlett-Packard Dielectric Test Fixture, model 16453A. Dielectric properties can be measured on compression molded plaques 2.5 inches (64 mm) diameter and 0.050 inches (1.3 mm) thick). The dielectric loss factor of a material should be sufficient to insure the material is adequately RF receptive for the intended industrial or commercial application. Generally, values of dielectric loss factor of greater than about 0.05 are preferred for the RF receptive materials used for RF receptive material compositions. Clayton setting is a term referring to a setting of capacitance in the RF circuitry commonly adjusted to tune the RF circuit for optimal RF power at the distance of the seal.

The sealing process in general can be described in multiple steps as per Journal of Applied Polymer Science, vol. 51, 105-119 (1994). An RF sealing process can involve similar steps as the sealing process as discussed for similar heat sealing of layer materials, but where heat is not directly applied to the films. Instead, heat is generated by the RF receptive material interaction with an oscillating electric field applied across the seal area. Molecular motion induced by the electric field produced by the electrodes of the conventional RF sealing apparatus causes the heat generation. For example, an RF sealing process between surfaces of film(s) may typically begin by heating the RF receptive polymers in the sealing area(s) of one or both films to, in turn, sufficiently heat at least one of the sealing surfaces in order to achieve a seal having the desired seal strength.

A particularly common and preferred sealing frequency for industrial and medical applications is about 27.12 MHz. Minimum amount of power and shortest seal time are preferred for low cost and best efficiency. Conventional techniques and welding apparatuses, that includes a pair of electrodes to generate the RF electromagnetic radiation, are well known to those skilled in the art. Optionally, a buffer, such as Bakelite®, may be applied to one or more electrodes to aid in avoiding arcing.

For example, Vertical Form Fill Seal (VFFS) is a means of producing bags or pouches from flexible packaging film using, for example, both fin and lap seals. This process is described in “Form/Fill/Seal, Vertical” by George Moyer in The Wiley Encyclopedia of Packaging Technology, M. Bakker Ed. (John Wiley, 1986, p. 367-369).

“Seal strength” means the force required to pull a seal apart, which can be measured in accordance with ASTM F88. A seal having a seal strength below about 0.46 pounds per inch (lb/in) (0.08 Newtons per millimeter (N/mm)) is considered here to be an ineffective seal for use in intended commercial and industrial applications. Preferably, the seals obtainable and provided according to the present invention have a seal strength of greater than about 0.46 lb/in (0.08 N/mm), more preferably greater than about 0.57 lb/in (0.1 N/mm), more preferably greater than about 1.1 lb/in (0.2 N/mm), and more preferably greater than about 2.9 lb/in (0.5 N/mm). Alternatively, in some embodiments of the present invention, so-called peelable seals are obtainable having seal strength greater than 0.46 lb/in (0.08 N/mm), preferably greater than about 1.1 lb/in (0.2 N/mm) but less than about 4.6 lb/in (0.80 N/mm), preferably less than about 2.9 lb/in (0.5 N/mm). As known, so-called permanent seals can have higher seal strengths, up to about 3.5, 5 or even 10 N/mm,

An RF sealable film, such as a multilayer film, of the present invention, depending on factors such as desired properties, costs of manufacture, end use, etc., may include, for example, at least two layers, preferably at least three layers, preferably at least four layers, more preferably at least about five layers, and most preferably at least about seven layers. In some embodiments, the multilayer film may include many more layers, depending on the requirements and desired properties for an end-use application.

In some embodiments, a multilayer film of the present invention having a “sealing” surface on outer seal layer (“A Layer”) may be formed in a layered organization with other layers represented by “B”, “C”, “D”., etc., such as but not limited to ABA, ABE, ABCA, ABCE, ABCB, ABCBA, ABCBE, ABDCDBA, ABDCDBE, etc. The outer or surface layers of films are sometimes also referred to as skin layers. As described in U.S. Pat. No. 5,685,128, the multilayer films of these types may be formed by well-known cast, blown, and/or lamination co-extrusion methods. In some embodiments, the layered organization patterns as shown above may be a repeating pattern within the multilayer film, or one of the layers shown may have a sub-layered micro layer structure and be made up from tens, hundreds or thousands of sub-layers of the same or different polymers. Both symmetric and asymmetric multilayer films are possible and may provide different surface characteristics if so required.

The outer seal layer or “A” layer in the films according to the present invention consists essentially of a substantially isotactic polypropylene composition. The other required substantially adjacent “B” layer is prepared from an RF receptive material composition that is typically a polymer composition exhibiting RF receptivity due to one or more RF receptive material. As used herein, “substantially” adjacent refers to the fact that layers A and B can be immediately adjacent and directly contacting layers (which is preferred) or, alternatively may not be directly in contact but, for example, may be joined or adhered to each other by a relatively thin adhesive or tie layer which does not prohibit the RF sealability of layer A. One or more optional layers may include a polymer which may or may not be RF active, but may be employed in the film structure for imparting the polymers' functionalities or properties. The additional layer(s) including “C”, “D” and “E” layers may be interposed within the multilayer film and may impart desired functionalities. For example, the “C” and/or other optional layers may comprise a barrier polymer, such as polyvinylidene chloride, copolymers of ethylene and vinyl alcohol (EVOH), acrylonitrile polymers or polyamides. An “E” layer, for example, may be an alternate seal composition such as one having a slightly higher or lower melt temperature or a non-sealing layer.

In one embodiment, wherein the multilayer film has an ABA structure, the “A” layers consist essentially of substantially isotactic polypropylene(s), and the “B” layer comprises an RF receptive material composition. In another embodiment, wherein the multilayer film has an ABCBA structure, the “A” layers consist essentially of substantially isotactic polypropylene(s), the “B” layer comprises a an RF receptive material composition having the ability to adhesively bond the A and C layers, and the “C” layer comprises a polymer providing barrier properties, such as polyvinylidene chloride copolymer or ethylene vinyl alcohol copolymer. In other alternative embodiments, structures according to the present invention might employ a thin layer between the A and B layers providing that sealability is sufficiently maintained. Such a layer could be an adhesive or tie layer or might add other functional attributes to the film structures such as improved chemical resistance, higher modulus or improved toughness.

FIG. 3 illustrates the general layer structure of a three layer film according to one possible embodiment of the present invention. Outer sealing layer 10 consists essentially of a substantially isotactic polypropylene composition and has a sealing surface 1 and an inner surface 3 adjacent to and contacting layer 11, the RF receptive layer. Adjacent to the outer sealing layer 10, RF receptive layer 11 is an RF receptive material composition comprising an RF receptive material and has a surface 4 adjacent to and contacting the inner surface 3 of the outer sealing layer 10. Layer 12 is an optional layer serving as the other outer layer and having an outer surface 2. Layer 12 may also be a sealing layer and have the same composition as layer 10 in which case surface 2 is also an outer sealing surface and the film can be employed to provide either lap or fin seals. Alternatively, layer 12 may have an alternate seal composition that also sufficiently heats under RF heating conditions and provides or helps to provide a seal with surface 1 of layer 10. For example, the alternate seal composition may have a slightly higher melt temperature than the composition of layer 10, such as, for example, a different substantially isotactic polypropylene composition or blends of two or more substantially isotactic polypropylene compositions. In this case also, surface 2 is a sealing surface and the film would be suitable for making either a lap seal or a fin seal. Alternatively, layer 12 may be a non-sealing layer, in which case surface 2 is non-sealable and only fin seals would be used to make RF sealed structures from this film.

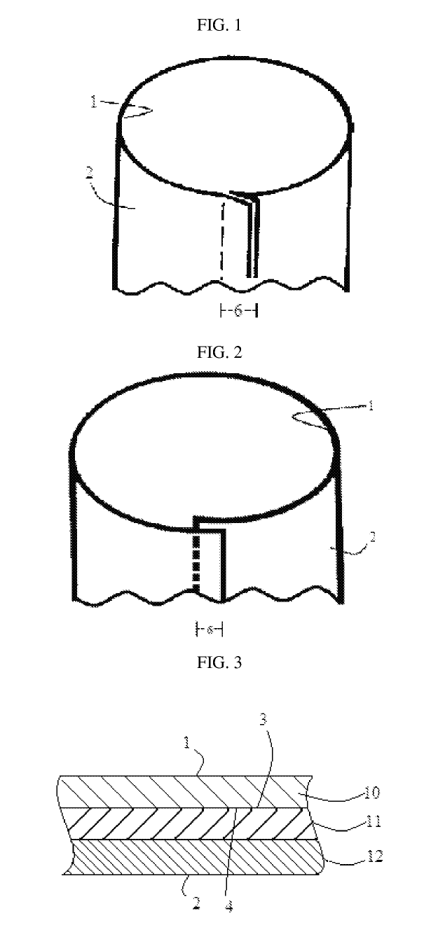

As shown in FIG. 1, in sealing area 6 of an example fin-sealed film structure according to the present invention, a portion or area of sealing surface 1 of layer 10 is RF sealed to another portion or area of sealing surface 1 to make a generally tube-shaped sealed article. This could obviously be employed with additional folding and sealing of the film to make bag-, pouch- or envelope-shaped articles. Surface 2 is not RF sealed, and thus layer 12 may be a non-sealing layer having a non-sealable surface 2. The seal portion or “fin” of the shown fin seal, unless folded to be generally parallel, is generally in a different plane than the immediately adjacent and unsealed portions of the two film surfaces being sealed

As shown in FIG. 2, in a sealing area 6 of an example lap-sealed film structure according to the present invention, an area of sealing surface 1 of layer 10 is RF sealed to an area of sealing surface 2 of layer 12. Accordingly, layer 12 has a composition that effects a seal, e.g., the same composition as layer 10 or an alternate seal composition as discussed above with respect to FIG. 3. This referred as a lap seal where the seal area or portion is formed by overlapping the film surface being sealed and is generally in the same plane as the immediately adjacent and unsealed areas of the two film surfaces being sealed

FIG. 1 and FIG. 2 can also be seen to represent situations according to the present invention where, instead of the same film being folded or looped and sealed to itself to make a tube, two separate films, film sheets or film pieces can be have their surface layers sealed with lap or fin seals, the sealing layers then being the same, similar or completely different compositions.

Outer Seal Layer Consisting Essentially of Substantially Isotactic Polypropylene Composition

In the present invention, the outermost, or seal, layer consists essentially of a substantially isotactic propylene polymer. The term “consists essentially of” or “consisting essentially of” as used herein is to be construed to indicate that the addition or use of additives or other components do not result in the seal layer having a dielectric loss factor greater than 0.01, and do not substantially inhibit desired film and seal properties, such as chemical resistance or clarity, as described below. The substantially isotactic polypropylene itself is not receptive to RF radiation and has a dielectric loss factor less than 0.01, but, according to the present invention, is RF sealable and may be RF sealed when substantially adjacent or adjacent to and heated by a layer having an RF receptive material composition. The outermost, or seal, layer may include such propylene copolymers with differing ratios of comonomer such as ethylene to give varying levels of chemical resistance. The outermost, or seal, layer may include a blend of differing substantially isotactic propylene polymers or compositions or blends with minor amounts of one or more additional, compatible polymers. In another embodiment, both of the outermost layers of a film each consist essentially of a substantially isotactic propylene composition that may be the same or different compositions. Alternatively, the outermost layers each consist essentially of different substantially isotactic propylene compositions. For example, such multilayer films with different outermost, or seal, layers may be useful for vertical form fill sealing process where differing melt temperatures are desired.

The preferred substantially isotactic propylene polymer may be described as follows and is a propylene/alpha-olefin copolymer. The propylene/alpha-olefin copolymer is characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by ¹³C NMR spectra. ¹³C NMR spectroscopy is one of a number of techniques known in the art for measuring comonomer incorporation into a polymer. An example of this technique is described for the determination of comonomer content for ethylene/α-olefin copolymers in Randall (Journal of Macromolecular Science, Reviews in Macromolecular Chemistry and Physics, C29 (2 & 3), 201-317 (1989)). Due to the novel molecular architecture, substantially isotactic propylene copolymers are significantly different than homopolymer or random copolymer polypropylene.

The substantially isotactic propylene/alpha-olefin copolymer may have a melt flow rate in the range of from about 0.1 to about 25 g/10 minutes, measured in accordance with ASTM D-1238 (at 230° C./2.16 Kg). All individual values and subranges from about 0.1 to about 25 g/10 minutes are included herein and disclosed herein; for example, the melt flow rate can be from a lower limit of about 0.1 g/10 minutes, about 0.2 g/10 minutes, or about 0.5 g/10 minutes to an upper limit of about 25 g/10 minutes, about 15 g/10 minutes, about 10 g/10 minutes, about 8 g/10 minutes, or about 5 g/10 minutes. For example, the propylene/alpha-olefin copolymer may have a melt flow rate in the range of from about 0.1 to about 10 g/10 minutes; or in the alternative, the propylene/alpha-olefin copolymer may have a melt flow rate in the range of from about 0.2 to about 10 g/10 minutes.

The substantially isotactic propylene/alpha-olefin copolymer has a crystallinity in the range of from at least about 1 percent by weight (a heat of fusion of at least 2 Joules/gram) to about 30 percent by weight (a heat of fusion of less than 50 Joules/gram). All individual values and subranges from about 1 percent by weight (a heat of fusion of at least 2 Joules/gram) to about 30 percent by weight (a heat of fusion of less than 50 Joules/gram) are included herein and disclosed herein; for example, the crystallinity can be from a lower limit of about 1 percent by weight (a heat of fusion of at least 2 Joules/gram), about 2.5 percent (a heat of fusion of at least 4 Joules/gram), or about 3 percent (a heat of fusion of at least 5 Joules/gram) to an upper limit of about 30 percent by weight (a heat of fusion of less than 50 Joules/gram), about 24 percent by weight (a heat of fusion of less than 40 Joules/gram), about 15 percent by weight (a heat of fusion of less than 24.8 Joules/gram) or about 7 percent by weight (a heat of fusion of less than 11 Joules/gram). For example, the propylene/alpha-olefin copolymer may have a crystallinity in the range of from at least about 1 percent by weight (a heat of fusion of at least 2 Joules/gram) to about 24 percent by weight (a heat of fusion of less than 40 Joules/gram); or in the alternative, the propylene/alpha-olefin copolymer may have a crystallinity in the range of from at least about 1 percent by weight (a heat of fusion of at least 2 Joules/gram) to about 15 percent by weight (a heat of fusion of less than 24.8 Joules/gram); or in the alternative, the propylene/alpha-olefin copolymer may have a crystallinity in the range of from at least about 1 percent by weight (a heat of fusion of at least 2 Joules/gram) to about 7 percent by weight (a heat of fusion of less than 11 Joules/gram); or in the alternative, the propylene/alpha-olefin copolymer may have a crystallinity in the range of from at least about 1 percent by weight (a heat of fusion of at least 2 Joules/gram) to about 5 percent by weight (a heat of fusion of less than 8.3 Joules/gram). The crystallinity is measured via DSC method, as described above. The substantially isotactic propylene/alpha-olefin copolymer comprises units derived from propylene and polymeric units derived from one or more alpha-olefin comonomers. Exemplary comonomers utilized to manufacture the substantially isotactic propylene/alpha-olefin copolymer are C₂, and C₄ to C₁₀ alpha-olefins; for example, C₂, C₄, C₆ and C₈ alpha-olefins.

The substantially isotactic propylene/alpha-olefin copolymer comprises from 1 to 40 percent by weight of the units derived from one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the substantially isotactic propylene/alpha-olefin copolymer comprises from 1 to 35 percent by weight of units derived from one or more alpha-olefin comonomers; or in the alternative, the propylene/alpha-olefin copolymer comprises from 1 to 30 percent by weight of units derived from one or more alpha-olefin comonomers; or in the alternative, the propylene/alpha-olefin copolymer comprises from 3 to 27 percent by weight of units derived from one or more alpha-olefin comonomers; or in the alternative, the propylene/alpha-olefin copolymer comprises from 3 to 20 percent by weight of units derived from one or more alpha-olefin comonomers; or in the alternative, the propylene/alpha-olefin copolymer comprises from 3 to 15 percent by weight of units derived from one or more alpha-olefin comonomers.

The substantially isotactic propylene/alpha-olefin copolymer has a molecular weight distribution (MWD), defined as weight average molecular weight divided by number average molecular weight (M_{w}/Mₙ) of 3.5 or less; in the alternative 3.0 or less; or in another alternative from 1.8 to 3.0.

Such substantially isotactic propylene/alpha-olefin copolymers are further described in details in the U.S. Pat. Nos. 6,960,635 and 6,525,157, incorporated herein by reference. Such substantially isotactic propylene/alpha-olefin copolymers are commercially available from The Dow Chemical Company, under the tradename VERSIFY™, or from ExxonMobil Chemical Company, under the tradename VISTAMAXX™.

In one embodiment, the substantially isotactic propylene/alpha-olefin copolymers are further characterized as comprising (A) between 60 and less than 100, preferably between 80 and 99 and more preferably between 85 and 99, weight percent units derived from propylene, and (B) between greater than zero and 40, preferably between 1 and 20, more preferably between 4 and 16 and even more preferably between 4 and 15, weight percent units derived from at least one of ethylene and/or a C₄₋₁₀ α-olefin; and containing an average of at least 0.001, preferably an average of at least 0.005 and more preferably an average of at least 0.01, long chain branches/1000 total carbons, wherein the term long chain branch refers to a chain length of at least one (1) carbon more than a short chain branch, and wherein short chain branch refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. The maximum number of long chain branches in the propylene interpolymer is not critical to the definition of this embodiment of the instant invention, but typically it does not exceed 3 long chain branches/1000 total carbons. Such propylene/alpha-olefin copolymers are further described in details in the U.S. Provisional Patent Application No. 60/988,999 and International Paten Application No. PCT/US08/082,599, each of which is incorporated herein by reference.

In another embodiment, the substantially isotactic polypropylene composition comprises units derived from propylene and polymeric units derived from one or more alpha-olefin comonomers. The propylene/alpha-olefin copolymer may be VERSIFY® (The Dow Chemical Company) 3000 Plastomer, as described below. In another embodiment, the propylene/alpha-olefin copolymer may be VERSIFY® (The Dow Chemical Company) 3200 Plastomer, as described below.

The above-described substantially isotactic polypropylene composition materials are advantageously employed in the seal layer or layers of a multilayer film of the present invention.

Seal layer materials that do not incorporate substantially isotactic polypropylene composition materials, and instead incorporate random polypropylene copolymers and high density polyethylene copolymers, if used in comparable film structures, do not produce an appropriate RF seal under commercial or industrial processing conditions, including required processing time and power restrictions. Accordingly, random polypropylene copolymers and high density polyethylene copolymers are thus commercially impracticable in the RF sealable films according to the present invention. Typical such resins include, for example, PP DS6D21 and PPDS6D82, random polypropylene copolymers made by The Dow Chemical Company, and DMDA 8904 NT-7 HDPE, a high density polyethylene, made by The Dow Chemical Company, as described below.

The substantially isotactic polypropylene composition may be chosen to exhibit optimal properties for the given end-use application. The layer including the composition may include other known additives while maintaining the important features of the substantially isotactic polypropylene composition in the sealed area, such as chemical resistance and clarity. These additives may impart functional attributes, but should not detract from the film RF sealability characteristics. Additives that are suitable are non-RF receptive or are added in amounts that would not typically be used for RF activation, would not substantially affect RF characteristics and do not substantially detrimentally affect properties such as chemical resistance and clarity. Such additives may be incorporated into the layer consisting essentially of the substantially isotactic polypropylene composition and include, but are not limited to, process stabilizers, tackifiers, fire retardants and inorganic fillers. Some of the additives may improve the sealing of the film structure, for example, silicon dioxide. Some additives, like polybutylene or random polypropylene compositions, may be incorporated to impart peelable sealing characteristics. Random polypropylene compositions may be added in amounts less than 40 weight percent, preferably less than 30 weight percent and more preferably less than 20 weight percent, based on total weight of the outermost, or seal, layer. Further, natural and synthetic polymers and additives may be incorporated and/or blended into layers of the multilayer film as needed. Other typical additives commonly incorporated into polymer compositions for various functionalities include catalysts or accelerators; nucleators; clarifiers; antistatic agents; antifog agents; slip agents; antiblock additives; surfactants; flame and smoke retardants; porosity control agents; antioxidants; stabilizers; reinforcing agents; ignition resistant additives; colorants; extenders; cross-linkers; blowing agents; plasticizers; pigments; fillers; gas, liquid, moisture or chemical barrier functionalities; oxygen and/or odor scavenger functionalities; adhesive promoters such as maleic anhydride graft polymers, impact modifiers to improve low temperature toughness; components to control the degree of peel strength including but not limited to polybutylene compositions and/or random copolymer polypropylene compositions and the like. Such additives will generally be incorporated in conventional effective amounts.

In one embodiment, the seal layer consisting essentially of the substantially isotactic propylene composition may contain additives or materials that are not RF receptive or, that may have some RF receptivity but are used at low levels that do not make the layer RF receptive. Such materials could include a polymeric component such as an olefinic elastomer such as AFFINITY EG8100G (available from The Dow Chemical Company) to improve low temperature toughness. Furthermore, if desirable, a random copolymer propylene may be added to the substantially isotactic propylene composition in order to modify seal strength.

Moreover, such materials or levels of materials could include acid-modified or graft maleic anhydride modified polymers to improve adhesion of the seal layer to the adjacent layer. For example, polypropylene with graft maleic anhydride or propylene copolymer with acrylic acid may be added to the substantially isotactic propylene composition.

As used here and with regard to other polymer components, “graft maleic anhydride modified”, “anhydride functionality” or “anhydride functionalized” refers to polymers resulting from a reaction to graft or copolymerize or otherwise provide an ethylenically unsaturated carboxylic acid anhydride functionality, such as maleic anhydride (MAH) onto a polymer backbone. Polyethylene, polypropylene and ethylene copolymers, such as ethylene/vinyl acetate copolymer (EVA) serve as suitable backbone polymers. As an example of anhydride functionalized polymers, MAH-grafted (MAH-g) polymers are well-known and typically have a MAH content of from 0.05 to 1.5 wt %, based on total polymer weight. Commercially available MAH-g polyolefins include MAH grafted polyethylene resins sold as AMPLIFY GR® (The Dow Chemical Company), BYNEL® CXA MAH grafted ethylene/vinyl acetate copolymers (E.I. du Pont de Nemours and Company), MAH grafted polymers sold as PLEXAR® (Equistar Chemicals) and MAH grafted polymers sold as LOTADER® (Arekma Inc.).

RF Receptive Materials and RF Receptive Compositions and Layers Comprising RF Receptive Materials

As discussed above, “radio frequency (RF) receptive,” “RF receptivity,” “RF activity” and like terms refer to a material susceptible to dielectric activation via application of electromagnetic energy in the RF range, the application of which induces rapid heating of the material. “RF sealability,” “RF bonding” and “RF welding” refers to bonding of a sealable article to a portion of itself or to another article using such electromagnetic energy over an RF frequency range, about 1 Megahertz (MHz) to about 300 MHz.

The RF receptive materials that provide RF activity and heating in RF receptive compositions and layers can be selected from a wide range of known materials having dielectric loss factors of at least about 0.05, and including up to about 1.2 and even higher. Examples of such RF receptive materials include ethylene copolymers with one or more polar comonomer. Examples of these RF receptive ethylene copolymers include high pressure, free radical polymerized ethylene copolymers with one or more polar comonomer including for example, copolymers of ethylene and vinyl acetate, copolymers of ethylene and methyl acrylate, copolymers of ethylene and ethyl acrylate, copolymers of ethylene and carbon monoxide, copolymers of ethylene and n-butyl acrylate, terpolymers of ethylene, acrylic acid and carbon monoxide, terpolymers of ethylene, n-butyl acrylate and carbon monoxide, terpolymers of ethylene, methacrylic acid and carbon monoxide, terpolymers of ethylene, vinyl acetate and carbon monoxide, thermoplastic urethane, polyamides, polyesters, copolyesters and the like. In alternative embodiments, any combinations or blends of two or more of these may be employed in the RF receptive composition. These copolymers are commercially available from a variety of suppliers.

Examples of these ethylene copolymers (including terpolymers) include for example, ethylene vinyl acetate with a vinyl acetate content in an amount of 18-50% by weight, ethylene methyl acrylate copolymers with methyl acrylate in an amount between 20%-40% by weight, ethylene n-butyl acrylate copolymers with n-butyl acrylate content of between 20-40%, copolymers of ethylene and ethyl acrylate with ethyl acrylate in an amount of 12-45% by weight, copolymers of ethylene and carbon monoxide with carbon monoxide in an amount between 1-40% by weight, terpolymers of ethylene, acrylic acid and carbon monoxide with carbon monoxide in an amount between 1-40% by weight and acrylic acid between 2 to 25% by weight, terpolymers of ethylene, methacrylic acid and carbon monoxide with carbon monoxide in an amount between 1-40% by weight and methacrylic acid between 2 to 25% by weight, terpolymers of ethylene, vinyl acetate and carbon monoxide with carbon monoxide in an amount between 1-40% by weight and vinyl acetate between 8 to 50% by weight, terpolymers of ethylene, methyl acrylate and carbon monoxide with carbon monoxide in an amount between 1-40% by weight and methyl acrylate between 10 to 40% by weight, terpolymers of ethylene, n-butyl acrylate and carbon monoxide with carbon monoxide in an amount between 1-40% by weight and n-butyl acrylate between 10 to 40% by weight.

Examples of such commercially available RF receptive materials include EVATANE® EVA polymers and LOTRYL® ethylene/methyl acrylate copolymers from Arkema; ELVAX® EVA copolymers, BYNEL® MAH-g EVA polymers and ELVALOY® ethylene/vinyl acetate/carbon monoxide terpolymers all from du Pont, as described below. Modified versions of these copolymers including an anhydride functionality may be employed. For example, maleic anhydride modified versions of these copolymers may be employed.

RF receptive materials can also include RF receptive species of ionomeric polymers or copolymers or salts thereof, thermoplastic urethanes, polyacrylonitriles, ethylene vinyl alcohol with vinyl alcohol in an amount of 15% to 70% by weight, polyvinyl chloride, polyamides, polyesters, copolyesters and like polymers that are RF receptive.

RF receptive material compositions for use as the RF receptive layer can also comprise blends of the RF receptive polyamides and polyolefins made compatible by compatibilizing or coupling agents such as maleic anhydride-grafted polymers such as for example maleic anhydride grafted polyethylene, maleic anhydride grafted propylene or maleic anhydride grafted block copolymers.

It is also possible for the RF receptive material compositions to comprise as the RF receptive material one or more RF active inorganic fillers having particles with average size in the range of from about 10 nanometers up to about 100 microns including but not limited to ferroelectric materials such as barium titanate, zirconium doped barium titanate, strontium titanate, zirconia, and the like, or aluminosilicates (e.g., Zeolite ZE (CAS#1318-02-1)) or sodium aluminosilicates (e.g., molecular sieve type 4A, CAS#1344-00-9) and the like.

The RF receptive material composition(s) employed in one or more RF receptive material composition layers should incorporate sufficient RF receptive material to provide the necessary heating sufficient to provide the sealing capability for the selected sealable layer that is employed in the multilayer film, ranging from very low levels of highly RF active material to higher levels up to 100% by weight of the less RF active materials such as some of the ethylene-polar comonomer copolymers. In this regard, in varying embodiments of the present invention, the RF receptive material composition may incorporate from greater than about 1 weight percent, greater than about 5 weight percent, greater than about 10 weight percent and greater than about 25 weight percent of one or more RF receptive materials. As mentioned, the RF receptive material composition(s) can be up to 100 weight percent RF receptive material as in the case of some polymers and polymer blends, or can utilize lower levels in combination with materials that are not RF receptive, including levels of up to 99 weight percent, up to 95 weight percent and up to 90 weight percent.

Rather than specific RF receptive material levels or content, it is more important to obtain suitable levels of RF activity as typically measured by the dielectric loss factor for the composition and composition layer. Suitable RF receptive material compositions and their layers have been found to have a dielectric loss factors greater than about 0.05; greater than about 0.07, greater than about 0.09 and greater than about 0.1 depending upon their ability to achieve radio frequency sealing in the multilayer film structure. The maximum dielectric loss factor values could, in theory be very high, such as 1.2 or more recognizing however that polarity, cost, interlayer adhesion or other properties of such materials and/or compositions might make some of them difficult to employ in the structures according to the invention. Preferably, however, based on the generally known and usable RF receptive materials, the RF receptive material composition from which the layer is made would have a dielectric loss factor of less than about 1.2, preferably less than about 1 and more preferably less than about 0.9.

In alternative embodiments, the RF receptive material composition(s)/layer(s) may incorporate greater than zero and up to about 60 weight percent, preferably more than about 20 weight percent and more preferably more than about 30 weight percent, preferably less than about 50 weight percent, of ethylene/vinyl acetate copolymer, the balance preferably being ethylene/vinyl acetate/carbon monoxide terpolymer. The ethylene/vinyl acetate copolymer may incorporate greater than about 15, preferably greater than about 18, and less than about 35, preferably less than about 32 weight percent vinyl acetate, more preferably incorporating about 24.5 weight percent vinyl acetate. The ethylene/vinyl acetate/carbon monoxide terpolymer may incorporate from about 2 to about 15 weight percent, preferably about 2 to 12 weight percent, preferably about 5 to 10 weight percent carbon monoxide and about 3 to 40 weight percent, preferably about 5 to 30 weight percent, preferably about 13 to 30 weight percent vinyl acetate, and more preferably about 8 weight percent carbon monoxide and about 20 weight percent vinyl acetate, the balance being ethylene. The melt index (measured at 190 C/2.16 kg according to ASTM D1238) of the RF receptive material composition may be from 0.5 to 20, preferably 1 to 16.

Further, natural and synthetic polymers and additives may be incorporated and/or blended into the layers of the multilayer film as needed. In alternative embodiments, the RF receptive material composition includes blends including compatible olefin polymers optionally grafted with glycidyl methacrylate (“GMA”) and MAH, for example, gMAH-ethylene/methylacrylate and gMAH-ethylene/vinyl acetate.

In alternative embodiments, copolymers of ethylene and vinyl acetate and copolymers of ethylene and methyl acrylate may be used and are well-known in the art. For example, copolymers including at least about 15 to 35 weight percent of vinyl acetate or methyl acrylate and having a melt index (190 C/2.16 kg) of at least about 0.5 to about 50, more preferably at least about 1, more preferably at least about 1.5 and more preferably at least about 2 and up to about 50, more preferably up to about 40, more preferably up to about 30, more preferably up to about 20, and more preferably up to about 10 may be used.

In alternative embodiments, the copolymers optionally also have at least one additional monounsaturated comonomer polymerizable with ethylene and vinyl acetate and/or ethylene and methyl acrylate.

The layer made from the RF receptive material composition may be an inside layer or an outside backing layer in the multilayer film and, as in the cases of some of the ethylene-polar comonomer copolymers with known adhesive properties, it may also function as a tie layer that has sufficient adhesion to tie a further functional layer to the substantially isotactic polypropylene composition sealing layer.

The RF receptive material compositions may be chosen and formulated to exhibit optimal properties for the given end-use application. The radio frequency receptive material composition may include known additives that do not substantially inhibit properties such as RF activity, chemical resistance and, optionally, clarity. These additives may impart functional attributes, but do not detract from the film RF sealability characteristics. Such additives include, but are not limited to, process stabilizers, tackifiers, fire retardants and inorganic fillers. Typical additives commonly incorporated into polymer compositions for various functionalities include catalysts or accelerators; nucleators; clarifiers; antistatic agents; antifog agents; slip agents; antiblock additives; surfactants; flame and smoke retardants; porosity control agents; antioxidants; stabilizers; reinforcing agents; ignition resistant additives; colorants; extenders; cross-linkers; blowing agents; plasticizers; pigments; fillers; gas, liquid, moisture or chemical barrier functionalities; oxygen and/or odor scavenger functionalities; adhesive promoters such as maleic anhydride graft polymers, impact modifiers to improve low temperature toughness. Such additives will generally be incorporated in conventional amounts.

The RF sealable film, including a multilayer film, may have a thickness of at least about 0.5 mils (12.7 microns), preferably greater than about 1 mil (25.4 microns), more preferably greater than about 2 mils (50.8 microns) and most preferably greater than about 3 mils (76.2 microns). Depending on varying factors, such as desired end-use and costs of manufacture, the RF sealable film, including a multilayer film, may have a thickness less than about 100 mils (2.54 millimeters), preferably less than about 50 mils (1.27 millimeters) and more preferably less than about 30 mils (0.76 millimeters).

In some embodiments, a multilayer film of the present invention has a generally uniform thickness. This is intended to mean that the structure is substantially the same thickness throughout with minor, occasional and unintentional thickness differences. Thickness variation is generally less than 20%, preferably less than 15%, more preferably less than 10% and most preferably less than 5%. In other embodiments of the invention, the thickness of the multilayer film may be intentionally non-uniform, depending on factors such as desired properties, end use application, etc.

The outermost, or seal layer thickness, of a multilayer film according to the present invention, depends upon the application requirements and can vary considerably but is generally greater than about 5 volume percent, preferably greater than about 10 volume percent, and more preferable greater than about 20 volume percent of the total thickness of the multilayer film. Based on, for example, the desired properties, end-use application, and manufacturing costs and conditions, the outermost, or seal, layer thickness is generally less than about 80 volume percent, may be less than about 70 volume percent and preferably less than about 60 volume percent of the total thickness of the multilayer film.

The RF receptive material composition layer thicknesses, within the multilayer film, is not critical as long as effective to provide the necessary RF activity and heating but is typically greater than about 5 volume percent and up to about 90 volume percent, greater than about 8 volume percent, greater than about 12 volume percent, greater than about 16 volume percent, and greater than about 20 volume percent of the total thickness of the multilayer film. Based on, for example, the desired properties, end-use application, and manufacturing costs and conditions, the total RF receptive material composition layer thicknesses may be less than about 80 volume percent, less than about 70 volume percent and less than about 60 volume percent of the total thickness of the multilayer film.

Optional Layer(s)

In alternative embodiments of the multilayer film of the present invention, additional layers may be incorporated and provide additional functions to the film, including but not limited to barrier properties, toughness, stiffness, etc., where the additional layer(s) may optionally also have RF receptivity.

In one embodiment, the present invention includes a barrier multilayer film. The film may, in one embodiment, have five layers in the ABCBA or ABCBE layered organization. The ABCBA organization has two outer seal layers A. The ABCBE organization has outer seal layer A and a dissimilar, optionally sealing, outer layer E. Both layered organizations have a barrier layer C sandwiched between outermost, or seal, layers with RF receptive material composition layers B interposed between the seal and barrier layers. Further, the film may have more than five layers, for example, seven-layer structures in the form ABDCDBA or ABDCDBE, with optional encapsulating or tie layers D. The barrier layer may optionally exhibit RF receptivity, such as with polyvinylidene chloride resins.

Total barrier layer thicknesses depend upon the desired barrier property and barrier effectiveness and, within the base multilayer film, can be greater than about 4 volume percent and up to about 50 volume percent, more than about 6 volume percent, and more than about 8 volume percent of the total thickness of the multilayer film. Based on, for example, the desired properties, end-use application, and manufacturing costs and conditions, the total barrier layer thicknesses may be less than about 40 volume percent and less than about 30 volume percent of the total thickness of the multilayer film.

The barrier layer may include polyesters, including amorphous polyesters and copolyesters, such as polyethylene terephthalate and polybutylene terephthalate; polypropylenes; high density polyethylene (HDPE); polyamides including copolyamides and amorphous polyamides, polyacrylonitrile polymers; polyvinylidene chloride copolymers (PVDC); copolymers of ethylene and vinyl alcohol (EVOH); and the like. For example, the preferred barrier layers may comprise polyvinylidene chloride copolymers. Preparation of such copolymers is well known to those skilled in the art.

It is desirable and advantageous to be able to co-extrude the barrier layer with the substantially isotactic propylene composition seal layer and RF receptive material composition inner layer for optimal cost.

Polyvinylidene chloride polymers (also known as vinylidene chloride resins, compositions of vinylidene chloride, vinylidene chloride compositions, copolymers of vinylidene chloride, and PVDC) are well-known in the art. See, for example, U.S. Pat. Nos. 3,642,743 and 3,879,359 and include the SARAN® brand resins from The Dow Chemical Company. As used herein, the vinylidene chloride copolymers (PVDC) encompass copolymers, terpolymers, and higher polymers wherein the major component is vinylidene chloride, optionally and preferably having one or more mono-ethylenically unsaturated monomer (monounsaturated comonomer) copolymerizable with the vinylidene chloride monomer such as vinyl chloride, alkyl acrylates, alkyl methacrylates, acrylic acid, methacrylic acid, itaconic acid, acrylonitrile, and methacrylonitrile. Copolymers containing vinylidene and vinyl chloride (VDC/VC) may contain vinyl chloride monomer in amounts between about 15 and 20 weight percent. The molecular weight (Mw) of these VDC/VC copolymers may be typically about 80,000 to 120,000 g/mol.

Further, polyvinylidene chloride polymers may include methyl acrylate vinylidene chloride (VDC/MA) copolymers. These copolymers may contain methyl acrylate monomer in amounts between about 4 and 10 weight percent, preferably between about 4.5 and 9.0 weight percent of the total VDC/MA copolymer content. The Mw of these VDC/MA copolymers may typically be about 80,000 to 120,000 g/mol.

In one embodiment, the barrier layer includes a SARAN® resin XUS 32727.00 Developmental MA Barrier Polymer Blend (The Dow Chemical Company), as described below.

In general, the barrier layer composition may be chosen to exhibit optimal properties for the given end-use application. Further, well-known additives selected from those listed above in connection with other layer compositions and film layers and in conventional effective amounts may be incorporated into the layer to impart functional attributes to the films, but do not detract from the film RF sealability characteristics.

The films of the present invention as herein described may be used for various and numerous applications. The films may be formed into various types of structures, such as sheet, tube, molded articles, etc. For example, a film of the present invention may be a multilayer film made by conventional thermoplastic film fabrication processes, such as cast or blown co-extrusion, lamination methods or, calendering processes. A laminated multilayer film may be made via the known adhesive, thermal or extrusion lamination of layers where such a multilayer film could also comprise one or more layers of a co-extruded structure. Component layers or structures as well as the multilayer film may also be mono-axially or bi-axially oriented. As an example, the fabrication methods described in U.S. Pat. No. 5,685,128A may be employed.

In an alternate embodiment, the multilayer film may be prepared by lamination methods, such as adhesive, thermal or extrusion lamination. In adhesive and extrusion lamination the layers of the multilayer film, such as “A” and “B” may be separated by a thin adhesive layer, or tie layer possibly comprising more than one thin layer. For example, for multilayer films produced by lamination methods, see “Multilayer Flexible Packaging” by E. L. Martin in The Wiley Encyclopedia of Packaging Technology, M. Bakker Ed. (John Wiley, 1986, p 451-464) and “Laminating Machinery” in The Wiley Encyclopedia of Packaging Technology, M. Bakker Ed. (John Wiley, 1986, p 430-433). Such adhesive or tie layers, if used, are typically substantially thin so as not to add functional properties other than adhesive properties. For example, these processes may be used to form lamination multilayer films, such as a multilayer films including a biaxially oriented NYLON® layer adjacent to a substantially isotactic polypropylene composition layer.

In embodiments of the invention, films of the present invention may be a multilayer film including at least two layers. In another embodiment, the multilayer film includes at least three layers. In an embodiment, a multilayer film is radio frequency (RF) sealed to a portion of itself, thereby forming a fin and/or a lap seal, or to another article. FIG. 1 illustrates an exemplary fin-sealed film structure, where a portion of surface 1 of the outer seal layer of a film according to the present invention is sealed to another portion of surface 1 of the outer seal layer of the film in a seal area 6. FIG. 2 illustrates an exemplary lap-sealed film structure, where a portion of surface 1 of the outer seal layer of a film according to the present invention is sealed to a portion of surface 2 of a second outer seal layer of the film in a seal area 6.

The seals are described in “Plastics Film Technology and Packaging Applications” by Kenton R Osborn & Wilmer A Jenkins. Published by Technomic Publishing Co., Inc. 1992, pages 150-151.

Sealed film structures of the present invention may be used in various end-use applications, including in general, bags, containers, packages, etc. Particularly, the sealed structure may be beneficial in unit packaging applications, either rigid or flexible, such as for food applications and medical applications.

Exemplary food applications include dry food packaging, such as, for items that are sensitive to moisture, aroma and air exposure, that require storage for an indefinite amount of time, i.e., increased shelf life or long-shelf life requirements, such as, cereal liners, cookie liners, cracker liners and tubes, other snack food packaging, etc. Also, the sealable films and sealed film structures of the present invention may be used in meat and cheese processing and packaging, including luncheon meats and cheese slices and slabs, hot dogs and the like. Food packaging applications generally require barrier properties with respect to aroma, flavor, moisture, oxygen, carbon dioxide and nitrogen, etc.

Exemplary medical applications include medical collection bags, storage containers, infusion or intravenous bags, inflatable medical devices, pharmaceutical packaging, bandages, etc. Further applications include reinforced laminations for automotive interior devices and attachments, tents and tarps for outdoor usage, toys, roofing devices, floatation devices, inflatable devices, air mattresses, and textiles.

The present invention is illustrated in further detail by the following examples. The examples are for the purposes of illustration only, and are not to be construed as limiting the scope of the present invention.

### Examples 1-4 and Comparative Examples 1-5

The radio frequency (RF) sealable barrier film structures described in Table 1 below are radio frequency (RF) sealed using a Callanan® RF 2.0 kW welding machine operating at 80% power and a Clayton setting of 17. An RF frequency of 27.12 MHz is employed. In the welding machine, a buffer over the bottom electrode of 17 mil (0.43 mm) Bakelite® plastic is used. A fin seal is formed as shown in FIG. 1 having a sealing area 6 with a seal width of 0.5 inches (12.7 mm) based on electrodes of that width. The overlapped seal area is put into the sealing chamber of the RF welding machine with the surfaces of the two sealing areas in contact and then the electrodes are closed to contact the film surfaces. A preheat time of 0.5 seconds at 30% power is performed. The preheat process warms the sealable multilayer film in order to seat the electrode into better contact with the film to provide best power transfer and prevent arcing. The weld or seal time is 2 seconds. After sealing, a dwell time of 0.5 seconds is allowed before separating the electrodes. The seal pressure is 30 psi (2 bar). This is representative of providing a seal in a bag or other container prepared from these sealable films.

The RF seal is made between two sheets or plies of the sample sealable films. The sample barrier multilayer films that are sealed and tested, as shown below, are 152 to 178 micron five-layer ABCBA symmetrical multilayer films produced using a cast co-extrusion film process as generally shown or described in U.S. Pat. No. 5,685,128. The RF sealing process provides a fin seal and accordingly, the “A” layer of one film is RF sealed to the same side “A” layer of that film placed directly adjacent and in contact, thereby forming at the seal a ten-layer ABCBA-ABCBA film structure. The seal strengths of the film structures are then tested using ASTM F88 test method on an Instron® tensile tester, by cutting 25.4 mm strips of seal films, mounting a flap from each of these film structures into the tensile tester, and determining seal strengths by peeling the seal at 20 inch (0.5 meter)/minute.

In the following barrier film structures, “A” and “B” layers have compositions and thicknesses as shown in the table below, and the barrier composition layer “C” is 20 volume % of the total film structure and is PVDC copolymer blend SARAN® (The Dow Chemical Company) Resin XUS 32727.00 Developmental MA Barrier Polymer Blend. Examples 1-4 yield the desired RF seal performance and are barrier films structures having layer “A” consisting essentially of a substantially isotactic polypropylene composition adjacent to layer “B” comprising a radio frequency receptive material composition of EVATANE® brand EVA resin and/or ELVALOY® brand EVACO resins, as described. As shown, layer “A” in Comparative Examples 1-5 is not a substantially isotactic polypropylene polymer composition and those samples do not yield the desired RF seal performance. “No RF Seal” is listed when the seal strength is too low to measure on the tensile test apparatus.

Table 4 lists properties of the materials used for the examples.

TABLE 1

| | | F | | | | |
|---|---|---|---|---|---|---|
| | Total | Layer | | P Layer | | |
| | Structure | [B] | | [A] | | Seal |
| | Thickness | Total | RF Layer [B] | Total | PP Layer [A] | Strength |
| x. | (microns) | Volume % | Material | Volume % | Material | lb/in(N/mm) |
| | 152.4 | 0 | EVATANE | 0 | VERSIFY 3000 | 6.8 |
| | | | 24-03 | | Plastomer | (1.2) |
| | 177.8 | 4 | EVATANE | 6 | VERSIFY 3000 | 5.6 |
| | | | 24-03 | | Plastomer | (0.97) |
| | 152.4 | 6 | EVATANE | 4 | VERSIFY 3000 | 5.6 |
| | | | 24-03 | | Plastomer | (0.97) |
| | 152.4 | 0 | 75% EVATANE | 0 | VERSIFY 3000 | 7.9 |
| | | | 24-03 | | Plastomer | (1.4) |
| | | | 25% ELVALOY 4924 | | | |
| E1 | 177.8 | 6 | 60% | 4 | 50% VERSIFY | No |
| | | | EVATANE 24-03 | | 3000 Plastomer/50% Dow | RF Seal |
| | | | 40% ELVALOY 4924 | | DS6D21 PP | |
| E2 | 152.4 | 0 | EVATANE | 0 | Dow DS6D82 PP | No |
| | | | 24-03 | | | RF Seal |
| E3 | 152.4 | 0 | 75% EVATANE | 0 | Dow DS6D82 PP | No |
| | | | 24-03 | | | RF Seal |
| | | | 25% ELVALOY 4924 | | | |
| E4 | 152.4 | 0 | EVATANE | 0 | Dow DMDA-8904 | No |
| | | | 24-03 | | NT7 HDPE | RF Seal |
| E5 | 152.4 | 0 | 60% | 0 | Dow DMDA-8904 | No |
| | | | EVATANE 24-03 | | NT7 HDPE | RF Seal |
| | | | 40% ELVALOY 4924 | | | |

### Examples 5-6 and Comparative Examples 6-9

The radio frequency (RF) sealable barrier film structures described in Table 2 below are radio frequency (RF) sealed together in generally the same fashion as shown in Examples 1-4 above using a Callanan® RF 2.0 kW welding machine operating at 80% power or at 100% power, as noted, the indicated sealing time and a Clayton setting of 17 or 18 as shown. A fin seal is formed.

The RF seal is applied or performed between two sheets or plies of the sample sealable films. The sample barrier multilayer films that are sealed and tested, as shown below, are 152 micron three-layer ABA symmetrical multilayer films produced using a cast co-extrusion film process as generally shown or described in U.S. Pat. No. 5,685,128. The RF sealing process provides a fin seal and accordingly, the “A” layer of one film is RF sealed to the same side “A” layer of that film placed directly adjacent and in contact, thereby forming at the seal a six-layer ABA-ABA film structure. The film structures are then tested using ASTM F88 test method on an Instron® tensile tester, by cutting 25.4 mm strips of seal films, mounting a flap from each of these film structures into the tensile tester, and determining seal strengths by peeling the seal at 20 inch (0.5 meter)/minute.

Examples 5-6 yield the desired RF seal performance and are film structures having layer “A” consisting essentially of a substantially isotactic polypropylene adjacent to layer “B” comprising a radio frequency receptive material composition of EVATANE® and/or ELVALOY®brand EVA resins, as described. As shown, layer “A” in Comparative examples 6-9 is not a substantially isotactic polypropylene composition. For example, in comparative example 7, a high density polyethylene resin is employed and does not yield desired chemical resistance and stiffness. “No RF Seal” is listed when the seal strength is too low to measure on the tensile test apparatus.

The total structure thickness of each of the film structures shown in Table 2 is 6 mils (152.4 microns). The layer “B” comprising a radio frequency receptive material composition is 40 volume % of the total film structure. The layer “A” consisting essentially of a substantially isotactic polypropylene is 60 volume % of the total film structure.

Table 4 lists properties of the materials used for the examples.

TABLE 2

| | | | Seal Strength | Seal Strength | Seal Strength | Seal Strength |
|---|---|---|---|---|---|---|
| | | | lb/in(N/mm) @ 80% | lb/in(N/mm) @ 80% | lb/in(N/mm) @ 100% | lb/in(N/mm) @ 100% |
| | | PP Layer [A] | power, 2 sec weld, 17 | power, 2 sec weld, 18 | power, 7 sec weld, 17 | power, 7 sec weld, 18 |
| Ex. | RF Layer [B] Material | Material | Clayton setting | Clayton setting | Clayton setting | Clayton setting |
| 5 | EVATANE 24-03 | VERSIFY 3000 | No RF Seal | 0.18 (0.03) | 0.34 (0.06) | 7.8 (1.36) |
| | | Plastomer | | | | |
| 6 | 60% EVATANE 24-03/ | VERSIFY 3200 | 4.9 (0.85) | 5.4 (0.94) | 5.8 (1.01) | 7.9 (1.37) |
| | 40% ELVALOY 4924 | Plastomer | | | | |
| CE 6 | 60% EVATANE 24-03/ | ELVAX 3165LG | 4.5 (0.78) | 4.3 (0.75) | 5.0 (0.87) | 6.7 (1.17) |
| | 40% ELVALOY 4924 | EVA | | | | |
| CE 7 | 60% EVATANE 24-03/ | Dow DMDA-8904 | No RF Seal | No RF Seal | No RF Seal | No RF Seal |
| | 40% ELVALOY 4924 | NT7 HDPE | | | | |
| CE 8 | 60% EVATANE 24-03/ | Dow DS6D82 PP | No RF Seal | No RF Seal | No RF Seal | No RF Seal |
| | 40% ELVALOY 4924 | | | | | |
| CE 9 | 60% EVATANE 24-03/ | Dow DS6D21 PP | No RF Seal | No RF Seal | No RF Seal | No RF Seal |
| | 40% ELVALOY 4924 | | | | | |

### Examples 7-15

The radio frequency (RF) sealable barrier film structures described in Tables 3 and 3.1 below are radio frequency (RF) sealed together in generally the same fashion as shown in Examples 1-4 above using a Callanan® RF 2.0 kW welding machine operating at 80% power and a Clayton setting of 17. A fin seal is formed.

The RF seal is applied or performed between two sheets or plies of the sample sealable films. The sample barrier multilayer films that are sealed and tested, as shown below, are five-layer ABCBA symmetrical multilayer films produced using a cast co-extrusion film process as generally shown or described in U.S. Pat. No. 5,685,128. The RF sealing process provides a fin seal and accordingly, the “A” layer of one film is RF sealed to the “A” layer of another sheet of the same film placed directly adjacent and in contact, thereby forming at the seal a ten-layer ABCBA-ABCBA film structure. The film structures are then tested using ASTM F88 test method on an Instron® tensile tester, by cutting 25.4 mm strips of seal films, mounting a flap from each of these film structures into the tensile tester, and determining seal strengths by peeling the seal at 20 inch (0.5 meter)/minute.

In the following barrier film structures having a total structure thickness of 152.4 micrometers, the “A” and “B” layers have compositions and thicknesses as shown in the table below, and the barrier composition layer “C” is 20 volume % of the total film structure and is PVDC copolymer blend that is SARAN® (The Dow Chemical Company) Resin XUS 32727.00 Developmental MA Barrier Polymer Blend. Examples 8-16 yield the desired RF seal performance and are barrier films structures having layer “A” consisting essentially of a substantially isotactic polypropylene composition adjacent to layer “B” comprising a radio frequency receptive material composition of EVATANE® and/or ELVALOY® brand EVA resins, as described. Dyneon 5929, which is a fluoropolymer process aid is added to some formulations to reduce cast die face polymer build-up. SiO2 is added to some formulations as an antiblock agent.

Table 3.1 shows the sealing window for two of the film structures in Table 3.

TABLE 3

| | RF Layer | | PP Layer | | Seal |
|---|---|---|---|---|---|
| | [B] Total | RF Layer | [A] Total | PP Layer | Strength |
| Ex. | Volume % | [B] Material | Volume % | [A] Material | (N/mm)lb/in |
| 7 | 16 | EVATANE 24-03 | 64 | VERSIFY 3000 Plastomer | 5.6 (0.97) |
| 8 | 40 | EVATANE 24-03 | 40 | VERSIFY 3000 Plastomer | 6.8 (1.18) |
| 9 | 60 | EVATANE 24-03 | 20 | VERSIFY 3000 Plastomer | 8.4 (1.46) |
| 10 | 32 | 60% EVATANE 24-03/ | 48 | VERSIFY 3000 Plastomer | 6.4 (1.11) |
| | | 40% ELVALOY 4924 | | | |
| 11 | 32 | 60% EVATANE 24-03/ | 48 | 75% VERSIFY 3000/ | 2.4 (0.42) |
| | | 40% ELVALOY 4924 | | 25% VERSIFY 3200 | |
| 12 | 32 | 60% EVATANE 24-03/ | 48 | VERSIFY 3000 Plastomer + | 8.0 (1.39) |
| | | 40% ELVALOY 4924 | | 800 ppm Dyneon 5929 PPA | |
| 13 | 32 | 60% EVATANE 24-03/ | 48 | VERSIFY 3000 Plastomer + | 8.7 (1.51) |
| | | 40% ELVALOY 4924 | | 7000 ppm SiO2 + 800 ppm | |
| | | | | Dyneon 5929 PPA | |
| 14 | 32 | 60% EVATANE 24-03/ | 50 | 50% VERSIFY 3000/ | 8.6 (1.50) |
| | | 40% ELVALOY 4924 | | 50% VERSIFY 3200 + | |
| | | | | 7000 ppm SiO2 + 800 ppm | |
| | | | | Dyneon 5929 PPA | |
| 15 | 32 | 60% EVATANE 24-03/ | 50 | VERSIFY 3200 Plastomer + | 7.5 (1.31) |
| | | 40% ELVALOY 4924 | | 7000 ppm SiO2 + 800 ppm | |
| | | | | Dyneon 5929 PPA | |

TABLE 3.1

| | Seal Strength | Seal Strength | Seal Strength | Seal Strength | Seal Strength |
|---|---|---|---|---|---|
| | (N/mm)lb/in@ | lb/in(N/mm) @ | lb/in(N/mm) @ | lb/in(N/mm) @ | lb/in(N/mm) @ |
| | 40% power, | 50% power, | 60% power, | 70% power, | 80% power, |
| Ex. | 2 sec weld | 2 sec weld | 2 sec weld | 2 sec weld | 2 sec weld |
| 13 | no RF seal | no RF seal | no RF seal | 0.9(0.16) | 8.7(1.51) |
| 15 | 0.53 (0.09) | 6.7(1.17) | — | — | 7.5(1.31) |

Table 4 lists properties of the materials used for the examples.

TABLE 4

| | | | | | | |
|---|---|---|---|---|---|---|
| | | | Melt | Melt | | |
| | Description | | Index, | Index, | DSC | |
| | (comonomers | | g/10 min | g/10 min | Melting | Dielectric |
| | shown in weight | Density, | at 190 C./ | at 230 C./ | Point, | Loss |
| Polymers | percent) | g/cc | 2.16 kg | 2.16 kg | C. | Factor |

Propylene resins

| | | | | | |
|---|---|---|---|---|---|
| VERSIFY 3200 | 9% ethylene | 0.876 | 8.0 | 86 | <0.01 |
| Plastomer | | | | | |
| VERSIFY 3000 | 5% ethylene | 0.888 | 8.0 | 112 | <0.01 |
| Plastomer | | | | | |
| Dow DS6D82 | 5.8% ethylene | 0.900 | 7.0 | 134 | <0.01 |
| PP | | | | | |
| Dow DS6D21 | 3.7% ethylene | 0.900 | 8.0 | 142 | <0.01 |
| PP | | | | | |

Ethylene resins

| | | | | |
|---|---|---|---|---|
| Dow DMDA- | 0.952 | 4.4 | 131 | <0.01 |
| 8904 NT7 | | | | |
| HDPE | | | | |

RF Ethylene copolymers

| | | | | | |
|---|---|---|---|---|---|
| DuPont | 18% vinyl | 0.940 | 0.7 | 89 | 0.07 |
| ELVAX | acetate | | | | |
| 3165LG EVA | | | | | |
| Arkema | 24.5% vinyl | 0.945 | 3.0 | 79 | 0.10 |
| EVATANE 24-03 | acetate | | | | |
| DuPont | 20% vinyl | 1.030 | 15.0 | 70 | 0.45 |
| ELVALOY | acetate, 8% | | | | |
| 4924 | carbon | | | | |
| | monoxide | | | | |
| DuPont | 25% vinyl | 0.950 | 2.0 | 80 | 0.10 |
| BYNEL | acetate, 0.12% | | | | |
| CXA3861 | maleic | | | | |
| | anhydride | | | | |
| Arkema | 28% methyl | 0.950 | 7.0 | 65 | 0.15 |
| LOTRYL | acrylate | | | | |
| 28MA07 | | | | | |

PVDC barrier copolymer

| | | | | | |
|---|---|---|---|---|---|
| Saran XUS | 7.6% methyl | 1.700 | — | 151 | >0.01 |
| 32727.00 | acrylate | | | | |
| PVDC | | | | | |

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents. Further, it is to be fully understood that all of the foregoing is intended to be merely illustrative and is not to be construed or interpreted as being restrictive or otherwise limiting of the present invention.

1. A radio frequency sealable film, comprising an outer seal layer and a substantially adjacent radio frequency receptive layer, wherein the outer seal layer consists essentially of a substantially isotactic polypropylene composition and the radio frequency receptive layer comprises a radio frequency receptive material.

2. A sealable film, according to claim 1 comprising at least three layers including another outer layer.

3. A sealable film, according to claim 2 comprising at least five layers, including an inner barrier layer.

4. The film of claim 1, wherein the substantially isotactic polypropylene in the outer seal layer composition comprises at least about 87 weight percent propylene units and between about 1 and about 13 weight percent ethylene units.

5. The film of claim 1, wherein the substantially isotactic polypropylene in the outer seal layer composition comprises at least 91 weight percent propylene units and up to about 9 weight percent ethylene units.

6. The film of claim 1, wherein the substantially isotactic polypropylene composition has a melt flow rate of about 0.5 to about 12.0 g/10 minutes at 230 degrees Celsius/2.16 kilograms.

7. The film of claim 1, wherein the substantially isotactic polypropylene composition comprises a blend of two or more substantially isotactic polypropylene compositions wherein each composition has a different ethylene unit content.

8. The film of claim 1, wherein the radio frequency receptive material composition has a dielectric loss factor of at least about 0.5

9. The film of claim 8 wherein the radio frequency receptive material is selected from the group consisting of: copolymers of ethylene and vinyl acetate; copolymers of ethylene and methyl acrylate; copolymers of ethylene and ethyl acrylate; copolymers of ethylene and carbon monoxide; copolymers of ethylene and n-butyl acrylate; terpolymers of ethylene, acrylic acid and carbon monoxide; terpolymers of ethylene, n-butyl acrylate and carbon monoxide; terpolymers of ethylene, methacrylic acid and carbon monoxide; terpolymers of ethylene, vinyl acetate and carbon monoxide; anhydride modified terpolymers of ethylene, vinyl acetate and carbon monoxide; polyamides; polyesters; and thermoplastic urethanes.

10. The film of claim 9, wherein the radio frequency receptive material composition comprises: (a) from about 40 to 80 weight percent ethylene/vinyl acetate copolymer which comprises from about 15 to about 35 weight percent vinyl acetate and (b) from about 20 to about 60 weight percent ethylene/vinyl acetate/carbon monoxide terpolymer which comprises from about 2 to about 12 weight percent carbon monoxide and from about 13 to about 30 weight percent vinyl acetate.

11. The film of claim 2 comprising outer seal layers independently consisting essentially of substantially isotactic polypropylene composition(s) on opposing sides of and each substantially adjacent to radio frequency receptive layers.

12. The film of claim 3, wherein the barrier composition comprises at least one polymer selected from the group of polyvinylidene chloride copolymers, polyamides, polyesters, copolymers of ethylene and vinyl alcohol, high density polyethylene and polyacrylonitrile.

13. The film of claim 10, wherein the thickness of the radio frequency receptive layer is in the range of from about 12 volume percent to about 40 volume percent of the total thickness of the film.

14. The film of claim 1, wherein the outer seal layer and the radio frequency receptive layer are directly adjacent and in contact.

15. A method of making a seal between film surfaces, comprising:
applying radio frequency energy to a sealing area of a multilayer film according to claim 1, which applied energy is sufficient to heat the sealing area to a sealing temperature; and
contacting and sealing the sealing area to another sealing area on a surface of the same film or a different film to provide a seal between the contacted sealing areas of the film surfaces.

16. The method of claim 15, wherein the radio frequency energy is applied for less than or equal to about seven seconds.

17. A sealed film structure made by the method of claim 15.

18. The sealed film structure of claim 17, wherein the seal has a seal strength of greater than about 0.5 Newtons per millimeter (N/mm).

19. The sealed film structure of claim 17, wherein the seal has a peelable seal strength greater than about 0.08 N/mm but less than about 0.8 N/mm).

20. A fin- or lap-sealed film structure made by the method of claim 15, wherein the seal layers that are sealed together consist essentially of substantially isotactic polypropylene composition(s), which can be the same or different substantially isotactic polypropylene compositions.
